(19) United States
(12) Patent Application Publication
(10) Pub. No.: US 2002/0032593 A1
(43) Pub. Date: Mar. 14, 2002

(54) Method and system for determining cat scan availability

(76) Inventor: Phillip M. Berman, Coronado, CA (US)

Correspondence Address: Thomas H. Close, Patent Legal Staff, Eastman Kodak Company, 343 State Street, Rochester, NY, 14650-2201, US

(21) Appl. No.: 09/864,523

(22) Filed: May 24, 2001

Related U.S. Application Data
(60) Provisional application No. 60/207,633, filed on May 25, 2000.

(51) Int. Cl. G06F 17/60

(52) U.S. Cl. 705/8; 705/2

(57) ABSTRACT

A system for determining medical diagnostic equipment comprising: a database system for information regarding the availability of medical diagnostic equipment at various facilities throughout a geographic region; and a user interface connectable to said database system via a network, said user interface including software for accessing said database system via said network determine the availability of specified medical diagnostic equipment at facilities convenient to the user.

### CROSS REFERENCE TO RELATED APPLICATIONS

This is a 111A application of Provisional Application Ser. No. 60/207,633, filed on May 25, 2000.

### FIELD OF THE INVENTION

This invention relates in general to medical imaging systems and method for determining the availability of diagnostic medical scanners in a user's geographical area.

### BACKGROUND OF THE INVENTION

Computed Axial Tomography, better known as a “CAT” scan device is an invaluable tool used for diagnostics, detection and analysis of diseases such as heart disease, stroke and cancer. A CAR scan combines the use of a digital computer together with a rotating x-ray device to create detailed cross sectional images of various organs of the body.

Unfortunately, the CAT scanning device is a very expensive piece of equipment and often times sits empty and without use.

What is desired is a method and a system that will make public the schedule of availability of the CAT scan device and that will make known the nearest location to the user at which a CAT scan device is available. The availability of other medical diagnostic equipment such as Magnetic Resonance (MR), Nuclear Medicine (NM), Ultrasound (US), Digital Fluorography (DF), PET, etc., is also desirable. U.S. Pat. No. 5,848,395, 5,931,878, and 5,963,951 discloses various techniques which do not solve this problem.

### SUMMARY OF THE INVENTION

According to the present invention, there is provided a solution to these problems.

According to a feature of the present invention, there is provided a system for determining medical diagnostic equipment comprising: a database system for information regarding the availability of medical diagnostic equipment at various facilities throughout a geographic region; and a user interface connectable to said database system via a network, said user interface including software for accessing said database system via said network determine the availability of specified medical diagnostic equipment at facilities convenient to the user.

### ADVANTAGEOUS EFFECT OF THE INVENTION

The invention has the following advantages.

1. The schedule of availability of medical diagnostic equipment in a location convenient to a user is provided.

2. A user can easily schedule an appointment for use of conveniently located diagnostic medical equipment.

### BRIEF DESCRIPTION OF THE DRAWINGS

FIG. 1 is a block diagram of an embodiment of the present invention.

### DETAILED DESCRIPTION OF THE INVENTION

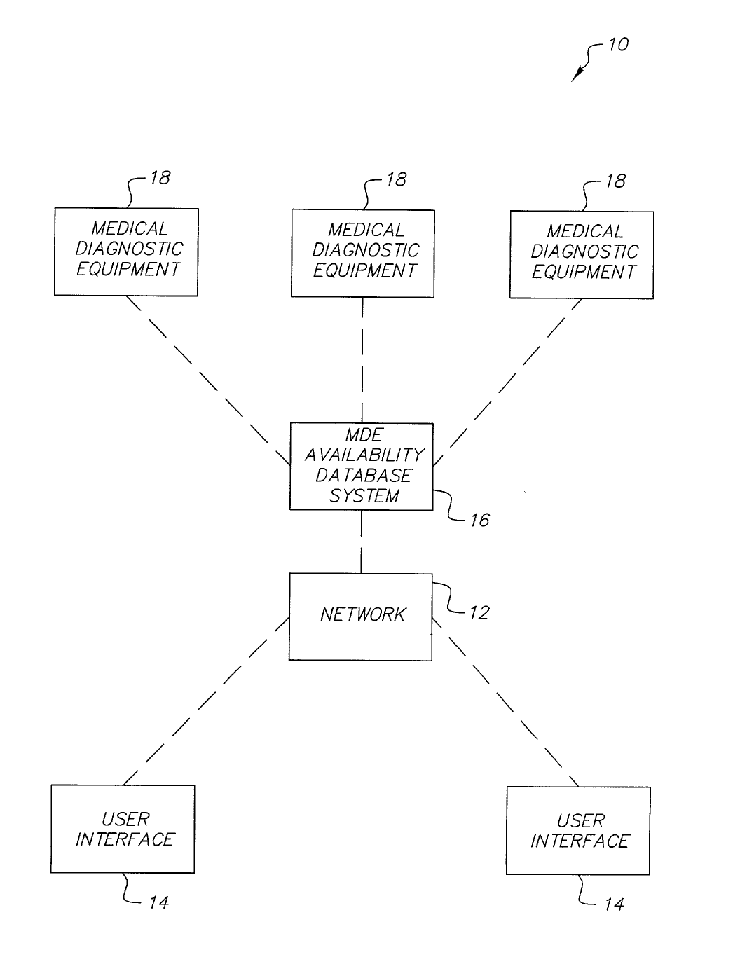

The invention relates to a system and a method for determining medical diagnostic equipment availability at clinics, hospitals and other facilities. As shown in FIG. 1, the system 10 comprises: a network 12 such as the Internet, a user's interface computer 14, that is connected to the network 12 and software residing in interface 14 for accessing information from the network 12 that is executed by the user through his or her computer 14. The network 12 makes available a frequently updated database 16 of information regarding the availability of medical diagnostic equipment (MDE) such as a CAT scan device 18 at various facilities throughout a large region such as the United States of America. The software works to access the availability schedule of the CAT scan device 18 at areas that are near to the user.

Employees at hospitals and clinics or alternatively workers who specialize in gathering information publish the CAT scan availability schedule and any other desired information in database system 16. The database can be a central server or be servers associated with the MDE site. Alternatively, an electronic interface to the hospital or clinic's resource scheduling program publishes the CAT scan availability schedule. The location of the CAT scan device 18, specifically, the zip code of the device location is published. This information is entered into a database 16 and is accessed over a network 12 such as the Internet. The schedule availability and location information for all CAT scan devices will appear on a display screen of a computer 14 connected to the network 12. Sorting through the available locations for CAT scans across a large region is possible, however it is a formidable task. Narrowing the available CAT scan locations may be accomplished by searching. For example, CAT scan location entries that contain a certain state or city name may be searched. However, this still may render a large number of CAT scan locations.

In one embodiment of the invention, software resident in user interface computer 14 is used to access the database 16 of schedules of availability for the CAT scan device 18. Specifically, with the software, a user may input his or her zip code or a zip code corresponding to an area in which he or she wishes to find a CAT scan device 18 that is available for use. The software, after having received the inputted zip code, assesses the CAT scan availability schedule from a network for the clinic, hospital or facility having a CAT scan device 18 that is nearest to the location corresponding to the zip code. Other data, apart from nearest location could be searchable, such as types of acceptable insurance, types of acceptable credit cards, special features of the equipment, access conditions or limitations, attendant availability confirmation.

After determining the CAT scan device 18 availability at a location nearest to the user, as well as other searchable criteria, the user may indicate that he or she is interested in receiving a certain time slot for a CAT scan. He or she may either contact the hospital, clinic or facility electronically or receive contact information for such hospital, clinic or facility over the network.

Although the present invention has been described with specific reference to a CAT scan device, it will be understood by those skilled in the art that the invention is also applicable to other medical diagnostic equipment such as MR, NM, US, DF, PET medical diagnostic treatment equipment.

The invention has been described in detail with particular reference to certain preferred embodiments thereof, but it will be understood that variations and modifications can be effected within the spirit and scope of the invention.

### PARTS LIST

10 system

12 network

14 user's interface

16 MDE availability database system

18 medical diagnostic equipment

What is claimed is:

1. A system for determining medical diagnostic equipment comprising:
a database system for information regarding the availability of medical diagnostic equipment at various facilities throughout a geographic region; and
a user interface connectable to said database system via a network, said user interface including software for accessing said database system via said network determine the availability of specified medical diagnostic equipment at facilities convenient to the user.

2. The system of claim 1 wherein said software enables said user to schedule an appointment to use available medical diagnostic equipment at a convenient location.

3. A method for determining the availability of medical diagnostic equipment comprising;
providing a database system for information regarding the availability of medical diagnostic equipment at various facilities throughout a geographic region; and
connecting to said database system via a network by means of a user interface which includes software for accessing said database system to determine the availability of specified medical diagnostic equipment at facilities convenient to the user.

4. The method of claim 3 including using said user's interface software to schedule an appointment to use available medical diagnostic equipment at a convenient location.
